(19) United States
(12) Patent Application Publication
(10) Pub. No.: US 2017/0091836 A1
(43) Pub. Date: Mar. 30, 2017

(54) CHARITY KIOSK THAT RECEIVES CASINO GAMING VOUCHERS

(71) Applicant: ROBERT A. LUCIANO, JR., RENO, NV (US)

(72) Inventor: ROBERT A. LUCIANO, JR., RENO, NV (US)

(73) Assignee: VICTORIA PARROTT, TIBURON, CA (US)

(21) Appl. No.: 15/274,428

(22) Filed: Sep. 23, 2016

Related U.S. Application Data
(60) Provisional application No. 62/233,127, filed on Sep. 25, 2015.

(51) Int. Cl. G06Q 30/02; G06Q 50/34; G07F 17/32; G06Q 20/02

(52) U.S. Cl. CPC G06Q 30/0279; G06Q 30/0209; G06Q 20/027; G06Q 30/0226; G06Q 50/34; G07F 17/3255

(57) ABSTRACT

A charity kiosk system and method that receives a plurality of casino gaming vouchers is described. The charity kiosk system includes a charity kiosk client and a slot accounting system that are communicatively coupled to one another. The charity kiosk client includes a voucher scanner that reads a casino gaming voucher having a monetary value and an identification module that determines a player identity associated with a particular patron. Additionally, the charity kiosk client includes a display that presents a variety of selectable charities. The charity kiosk client associates the monetary value from the casino gaming voucher with the particular patron and the charity selection input. The slot accounting system tracks the casino gaming voucher and transfers the monetary value from the casino gaming voucher to the charity kiosk client. Subsequently, the charity kiosk client transfers the received monetary value to the selected charity.

### CROSS-REFERENCE

This patent application claims the benefit of Provisional Patent Application 62/233,127 entitled, “Charity Kiosk That Receives Casino Gaming Vouchers” filed on Sep. 25, 2015, which is hereby incorporated by reference.

### FIELD

The present invention relates to a charity kiosk that receives casino gaming vouchers. More specifically, the charity kiosk is configured as a stand-alone device that operates on the casino floor, which is configured to receive gaming vouchers such as Ticket-In-Ticket-Out (TITO) tickets, virtual vouchers accessible through a smartphone and funds from a smartphone e-wallet.

### BACKGROUND

The Method and System for Tracking Wagering Relations Donations by Herrington in U.S. Patent Publication 2009/0209327 teaches a system and method that allows a player of an electronic game to designate a portion of their wagers and/or winnings to be donated to a third party. For example, the player places a wager on a game device, event or proposition; the game is played, or the event or position occurs, and if the player's wager is successful, a portion of the amount won by the player is deducted from the player's winnings. A portion of the amount won by the player is transferred to a third party's account and may be recorded and the portion of the amount won by the player is associated with the player and the third party account to which the portion is transferred.

The Responsible Gaming Devices and Related Methods by DiMichele et al. in U.S. Patent Publication 2008/0108433 teaches a gaming device that receives a player's wager and a charitable donation pool is funded with a portion of the player's wager. During the gaming session, a running total of the monies contributed to the charitable are presented on a display to a player. DiMichele describes a responsible gaming system that funds and manages a charity pool, in which the charity pool may be funded with seed money from the casino bonus points and/or marketing dollars. The charity pool may also be funded with a portion of the player's wager and/or winnings. In one embodiment, a contribution from a player is matched by the gaming establishment.

The Donation Transaction Method and Apparatus by Molback et al in U.S. Pat. No. 5,909,794 teaches a donation apparatus configured to receive coins, cash, funds transfer authorization or credit charges and dispenses a donation receipt to the user, which the user may use to prepare or document income tax returns. The user is able to select among a plurality of charitable organizations to receive the donation.

The Charitable Contribution Centralization System and Apparatus by Helbling in U.S. Pat. No. 5,555,497 teaches a multiplicity of charitable collection stations with selectors for choosing the charity to which a contribution is destined, a change maker for issuing change if desired, a display for displaying information with respect to premiums available and contributions made, and a modem or other telecommunicator for two-way communications with a central station. The central station communicates with the individual charitable institutions to provide information as to monies collected and signals the machines as to premiums available like food-service items, travel awards and the like.

The Donation Kiosk by Wald et al. in U.S. Patent Publication 2012/0232980 encourages and facilitates more charitable donations to worthy causes. Weld describes methods, devices and systems that allow a consumer to set up a charitable target and make relatively small payments to reach the target. Additionally, the cash value of expiring consumer loyalty points can be calculated and offered to a user for a donation. Wald describes a physical kiosk that can be used for donations to charities. Wald also describes a method of alerting users to charitable target amounts. The method can also include receiving modifications to the charitable target amount. Wald also describes a kiosk that includes a housing, a display coupled to the housing, a network interface and a processor operatively coupled to the display and network interface; the processor is configured to allow a user to select a charitable organization.

The Method and Apparatus for Facilitating Charitable Donations by Baker et al. in U.S. Patent Publication 2008/0033855 teaches a method, apparatus and system for placing and operating an automated donation station. Baker describes an automated collection of charitable donations using a portable configurable electronic device.

### SUMMARY

A charity kiosk system and method that receives a plurality of casino gaming vouchers is described. The charity kiosk system includes a charity kiosk client and a slot accounting system that is communicatively coupled to one another. The charity kiosk client includes a voucher scanner configured to read a casino gaming voucher having a monetary value and an identification module that determines a player identity associated with a particular patron. Additionally, the charity kiosk client includes a display that presents a plurality of charities and a charity selection module that receives a charity selection input associated with a selected charity from the plurality of charities. The charity kiosk client associates the monetary value from the casino gaming voucher with the particular patron and the charity selection input. The slot accounting system tracks the casino gaming voucher and transfers the monetary value from the casino gaming voucher to the charity kiosk client. Subsequently, the charity kiosk client transfers the received monetary value to the selected charity.

In one embodiment, the charity kiosk system includes a charity kiosk server communicatively coupled to the charity kiosk client, the slot accounting system and a plurality of charity kiosk clients. The charity kiosk server monitors a total monetary value that is donated to each charity by the particular patron. In a further embodiment, the charity kiosk client includes a plurality of LED lights on the charity kiosk client, an LED controller electrically coupled to the LED lights, wherein the LED controller is communicatively coupled to the charity kiosk server, and the charity kiosk server is configured to send an LED instruction to at least one of the charity kiosk clients that activates the LED lights.

In another embodiment, the charity kiosk system includes a banking gateway communicatively coupled to the charity kiosk client and a banking input module disposed in the charity kiosk client that enables the charity kiosk client to access a player's bank account so that funds from the player bank account can be transferred by the charity kiosk client to the selected charity.

In a further embodiment, the charity kiosk system includes a casino management system communicatively coupled to the charity kiosk client and a player loyalty input module disposed in the charity kiosk client that enables the charity kiosk client to determine the player identity and a total award points associated with the player identity. The total award points are converted to a second monetary value by the casino management system so that the second monetary value can be transferred by the charity kiosk client to the selected charity.

In a still further embodiment, the charity kiosk client includes a wireless communication module that enabled the charity kiosk client to be communicatively coupled to a smartphone. Additionally, the player identity associated with the particular patron is stored in the smartphone.

### DRAWINGS

The present invention will be more fully understood by reference to the following drawings which are for illustrative, not limiting, purposes.

FIG. 1A, FIG. 1B and FIG. 1C show an illustrative perspective diagram of a charity kiosk client.

FIG. 2A and FIG. 2B show a front view of an illustrative charity kiosk client.

FIG. 3A and FIG. 3B show a side view of an illustrative charity kiosk.

FIG. 4 shows a back view of an illustrative charity kiosk.

FIG. 5A and FIG. 5B show a top view of an illustrative charity kiosk.

FIG. 6 shows a high level block diagram of an illustrative charity kiosk system.

FIG. 7 shows a block diagram of an illustrative charity kiosk client.

FIG. 8A and FIG. 8B show an flowchart of an user interacting with the charity kiosk client system

### DESCRIPTION

Persons of ordinary skill in the art will realize that the following description is illustrative and not in any way limiting. Other embodiments of the claimed subject matter will readily suggest themselves to such skilled persons having the benefit of this disclosure. It shall be appreciated by those of ordinary skill in the art that the transactional system and method described herein may vary as to configuration and as to details. The following detailed description of the illustrative embodiments includes reference to the accompanying drawings, which form a part of this application. The drawings show, by way of illustration, specific embodiments in which the invention may be practiced. It is to be understood that other embodiments may be utilized and structural changes may be made without departing from the scope of the claims

A networkable kiosk system and method that can read or scan casino gaming vouchers for charitable donations is described. The illustrative casino gaming voucher is a Ticket-In-Ticket-Out (TITO) ticket. The charity kiosk system includes a charity kiosk client and a slot accounting system that manages and monitors the casino gaming voucher transactions. The charity kiosk client reads a casino gaming voucher and determines a player identity. The charity kiosk client associates the monetary value from the casino gaming voucher with a casino patron and selected charity. The slot accounting system transfers the monetary value from the casino gaming voucher to the charity kiosk client, which then transfers the received monetary value to the selected charity.

The casino gaming vouchers are generated by slot machines or video lottery terminals that print tickets commonly known referred to as “ticket in/ticket out” or “TITO” tickets. A TITO ticket is a gaming instrument issued by a slot machine or video lottery terminal to a customer as a record of the wagering transaction and/or substitute for currency. Tickets are voucher slips printed with the name and the address of the gaming establishment, the stated monetary value of the ticket, date and time, machine number (i.e., asset or location), an 18-digit validation number, and a unique bar code. Tickets are a casino bearer “IOU” instrument. A customer can use a ticket at a machine or terminal that accepts tickets, or cash a ticket at a cage, slot booth, a redemption kiosk, or a pari-mutuel window at the gaming establishment.

In the illustrative embodiment, the charitable kiosk system is configured to receive a voucher, e.g. a TITO ticket, and the value of the voucher may be transferred to a charity. A TITO ticket is an illustrative complete voucher that can be redeemed through the use of automated reader or scanner. The charity kiosk system is networkable so one illustrative system can communicate with other charitable kiosks.

In general, a “voucher” is a printed document that has a value, which may be exchanged for goods, services, casino chips or other such financial instruments. In gaming, the definition of a voucher is more granular because there are a variety of different vouchers including a complete voucher, a duplicate voucher, an incomplete voucher and replacement voucher. A “complete voucher” (in gaming) contains, at a minimum, a complete validation number and is of a quality that can be redeemed through the use of an automated reader or scanner. A “duplicate voucher” is any reprinted complete voucher or incomplete voucher. An “incomplete voucher” contains, at a minimum, the voucher validation number printed across the printed leading edge and is manually redeemable, but is not of a quality that can be redeemed through the use of an automated reader or scanner. A “replacement voucher” is printed following a failed attempt to print a complete or incomplete voucher.

An illustrative voucher system includes, but is not limited to, a Ticket-In-Ticket-Out (TITO) system. A TITO ticket is an illustrative complete voucher that can be redeemed through the use of an automated reader or scanner. In addition to TITO tickets, the illustrative charity kiosk system receives electronic funds, points, cash and coins.

The charity kiosk system presented herein interfaces with a Casino Management System (CMS), which gathers specific data about players and enables casino properties to provide player tracking, marketing, player development and bonusing. The CMS is configured to interface with point-of-sale (POS) and hotel systems to manage the guest experience.

The charity kiosk system also interfaces with the Slot Accounting System (SAS) protocol, which enables casino properties to manage their slot machines or video lottery terminals. The SAS protocol supports TITO, system bonusing and cashless gaming.

The charity kiosk system is configured to comply with state gaming regulations, federal gaming regulations and casino specific regulatory requirements. Additionally, the charity kiosk system and methods presented herein receive TITO tickets from different manufacturers.

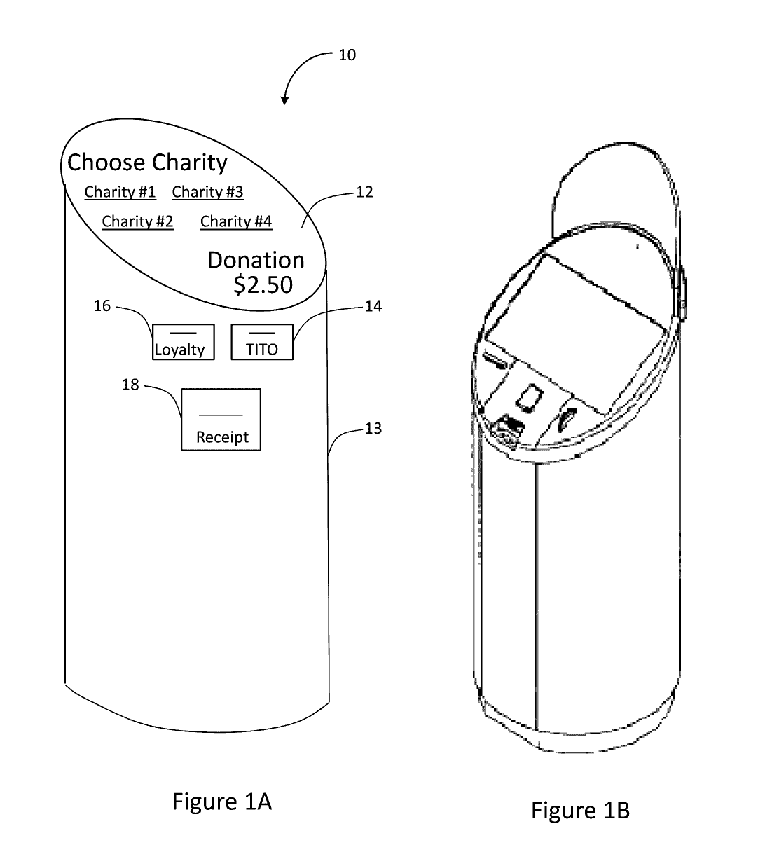

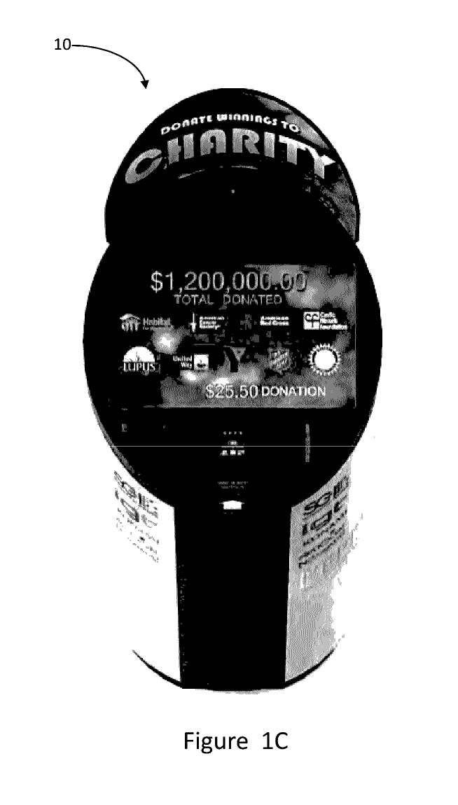

Referring to FIGS. 1A, 1B and 1C there is shown an illustrative perspective drawing of a charity kiosk client. The illustrative charity kiosk client 10 has a cylindrical base and an angled top face that includes a touch screen display 12. The Illustrative charities presented on the touch screen display 12 include, but are not limited to, the Salvation Army, the Red Cross and other such charitable organizations. The touch screen display also presents the donation amount to the user as shown in FIG. 1. The charity kiosk client 10 transfers the received monetary value from the casino gaming voucher to the selected charity.

The cylindrical base 13 includes a voucher scanner, an illustrative magstripe reader 16 that reads loyalty cards, and a receipt output 18. The charity kiosk client may also include a glass background (not shown) and a plurality of LED lights on the glass background, the charity kiosk client or any combination thereof.

The illustrative charity kiosk client 10 is disposed on the floor of a casino property near a bank of slot machines or adjacent to an Automated Teller Machine (ATM). The charity kiosk client 10 may be configured to receive funds from an e-wallet such as Apple Pay or Google Wallet. The illustrative charity kiosk client 10 may be configured to receive a charitable contribution from a registered user or from an anonymous user.

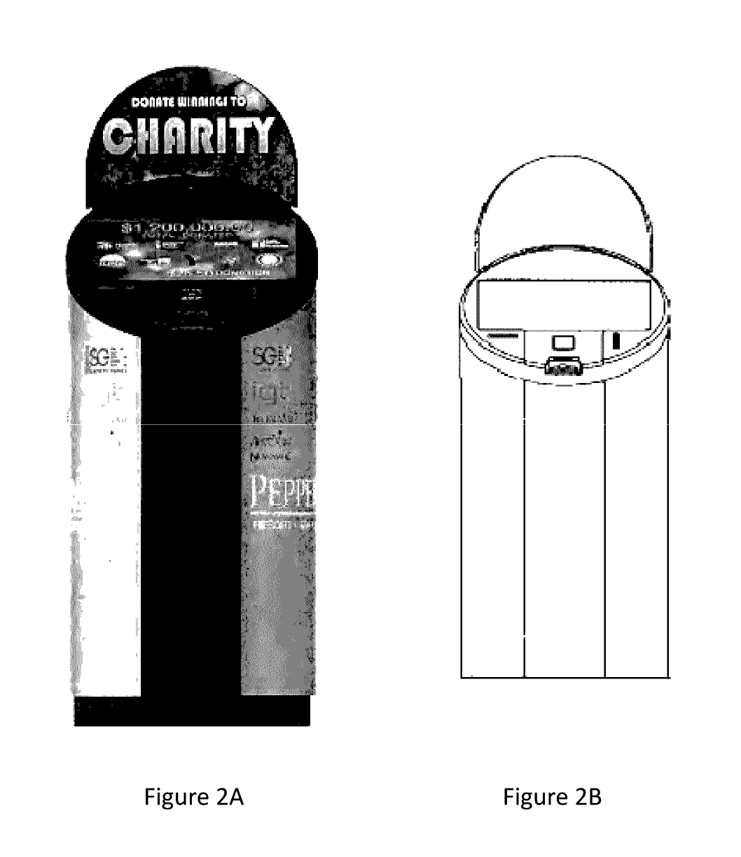

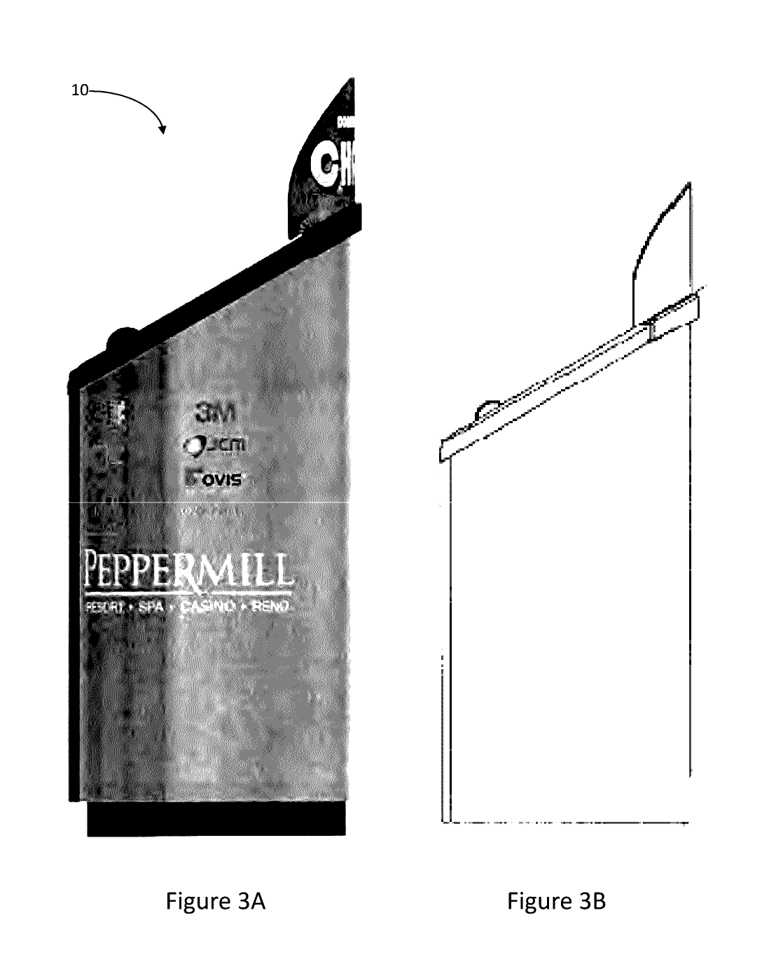

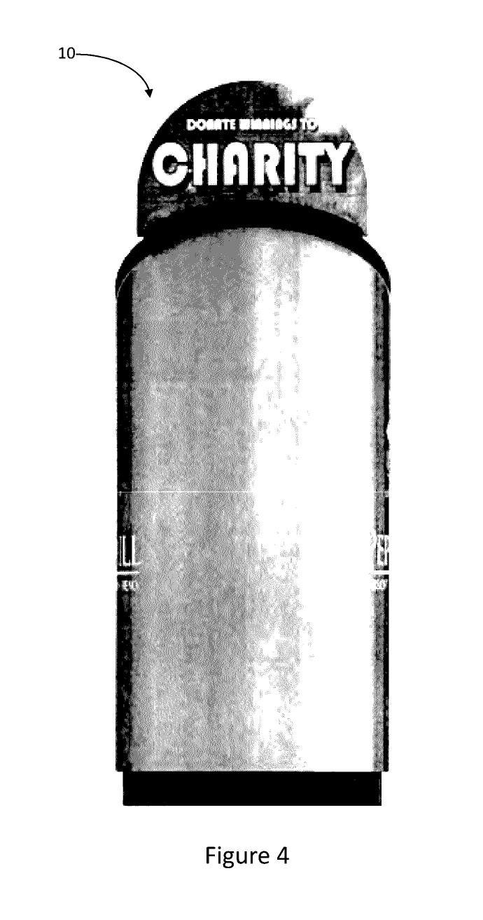

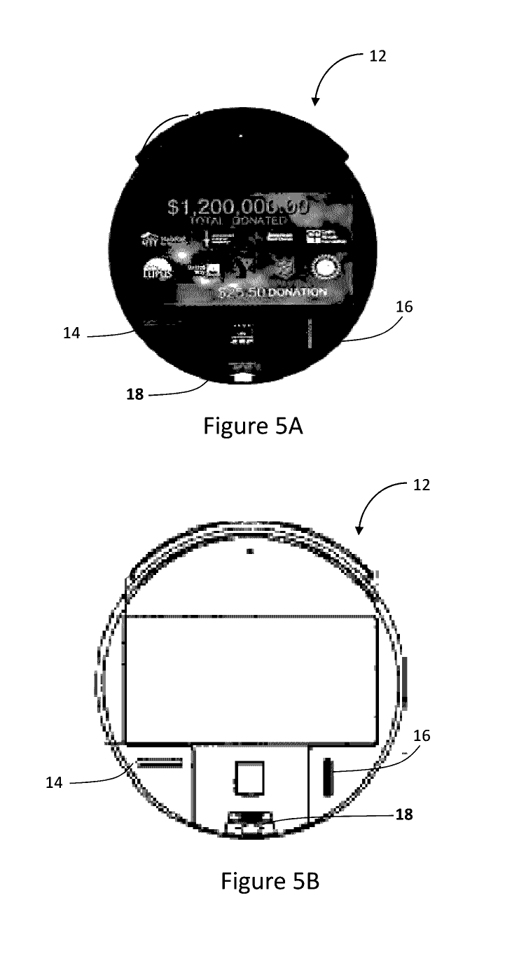

FIGS. 2A and 2B show front views of the illustrative charity kiosk client, and FIGS. 3A and 3B show side views of the illustrative charity kiosk client. FIG. 4 shows a back view of the illustrative charity kiosk client, and FIGS. 5A and 5B show top views of the illustrative charity kiosk client.

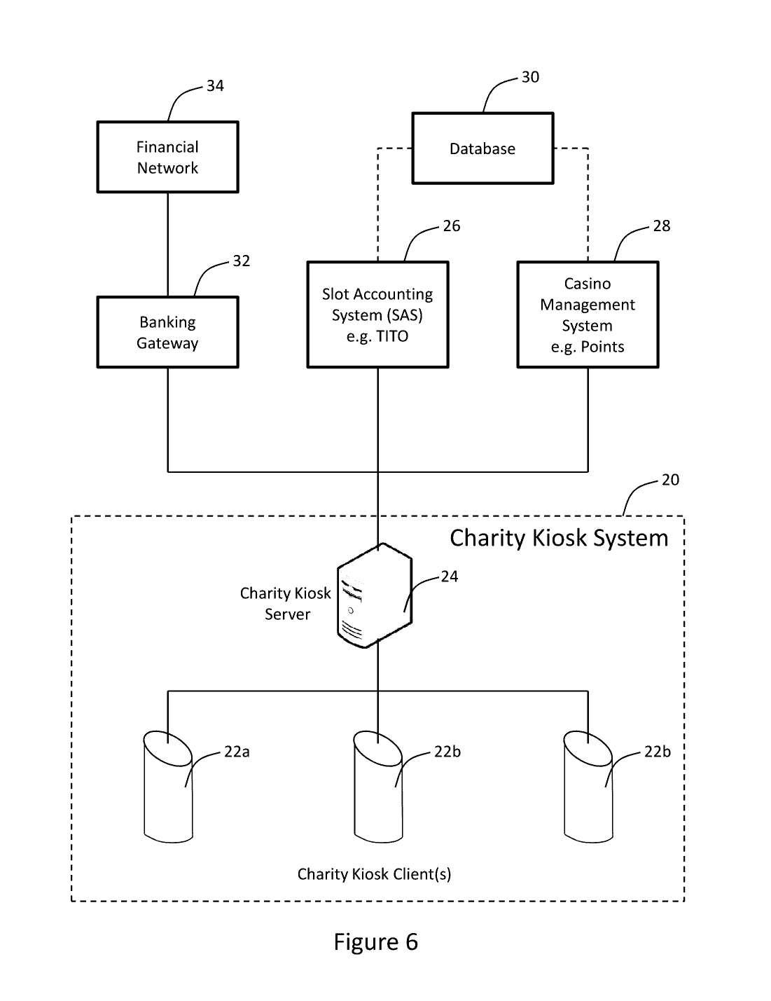

Referring to FIG. 6 there is shown a high level block diagram of an illustrative charity kiosk system. The illustrative charity kiosk system 20 includes a plurality of charity kiosk clients 22a, 22b and 22c that are communicatively to a charity kiosk server 24. The charity kiosk server 24 monitors the total monetary value that is donated to each charity by the particular patron. Additionally, the charity kiosk server 24 is configured to track charitable contributions for tax purposes. The charity kiosk server 24 may be further configured to provide an annual report that is sent via e-mail to the registered users.

The charity kiosk server 24 is communicatively coupled to a slot accounting system 26. The slot accounting system 26 (SAS) is communicatively coupled to the plurality of charity kiosk clients 22a through 22c. The slot accounting system 26 tracks the casino gaming voucher and transfers the monetary value from the casino gaming voucher to the charity kiosk client.

The charity kiosk system 20 is also communicatively coupled to a casino management system 28 that includes a loyalty card module that tracks player transactions on the gaming property. Additionally, the casino management system 28 tracks transactions, awarded loyalty points and redeemed loyalty points for each player. In operation, the casino management system 28 is communicatively coupled to each of the charity kiosk clients 22, which reads the loyalty cards.

In one illustrative embodiment, the total award points associated with the casino property player rewards program are converted to a second monetary value by the casino management system. The second monetary value can be transferred by the charity kiosk client to the selected charity.

The slot accounting system 26 and casino management system 30 include or are operatively coupled to a database 30. The illustrative database 30 is managed and controlled by the casino gaming operator

The charity kiosk system 20 is also communicatively coupled to a banking gateway 32, which provides access to funds in a bank account that can be transferred by the charity kiosk client 22 to a selected charity. More specifically, the banking gateway 32 is communicatively coupled to the charity kiosk client 22, which includes a banking input module (not shown) that enables the charity kiosk client to access a player bank account.

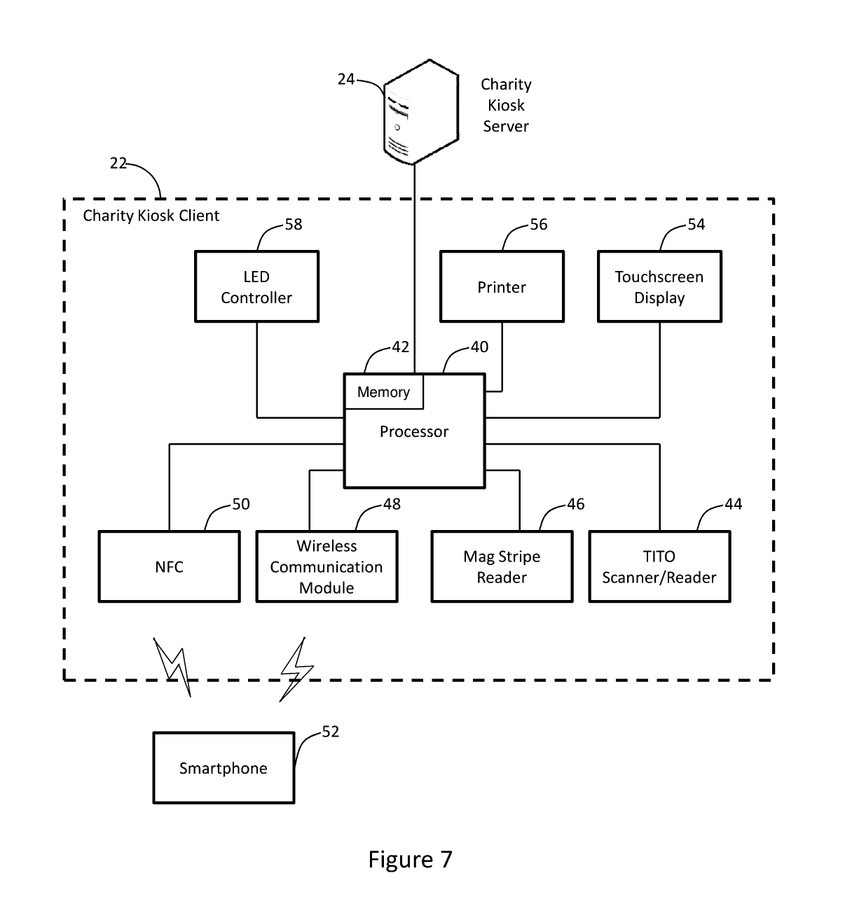

Referring to FIG. 7 there is shown a block diagram of an illustrative charity kiosk client. From the player's perspective, the illustrative charity kiosk client 22 receives the monetary value from casino gaming vouchers and transfers the monetary value to the player selected charity.

The illustrative charity kiosk client includes a central processing unit (“CPU”) 40, at least one static or random access memory 42 and at least one port that permits connection of one or more external memories or data storage devices. For illustrative purposes, the CPU may include an ARM-based microprocessor, RISC microprocessor, or other such microprocessor suitable for the intended purpose.

The processor 40 is communicatively coupled to a voucher scanner 44 that is configured to read a casino gaming voucher having a monetary value. Once the voucher scanner 44 reads the illustrative gaming voucher, e.g. a TITO ticket, the charity kiosk client 22 communicates with the slot accounting system 26 as described herein and the transfer of funds is completed.

The processor 40 is also coupled to a magstripe reader 46. The magstripe reader 46 is configured to read a loyalty card (not shown). The loyalty card provides an illustrative identification module that determines a player identity. Additionally, the loyalty card provides access to loyalty points, which may be converted to a second monetary value by the casino property. The second monetary value can be transferred by the charity kiosk client to the selected charity.

The processor 40 is also coupled to a wireless communication module 48 such as a WiFi or Bluetooth module. Additionally, the processor 40 is coupled to a near field communications (NFC) module 50. The wireless communication module 48 and NFC module 50 are configured to communicate with a smartphone 52. The smartphone may be running a mobile application that can be used to determine the player identity. The smartphone may also be used as an e-wallet as described in this patent application. The smartphone may also function as an identification module that is used to determine player identity.

A touch screen display 54 is also communicatively coupled to the processor 40. The touch screen display 54 has a user interface that allows the user to select a charity for donation. Generally, the touch screen display 54 presents a plurality of different charities. The touch screen display 54 also presents the total amount of donations made by the registered user. The touch screen display 54 also presents transactional information associated with the gaming voucher, the player's loyalty points and funds transferred from a player's bank account.

A printer 56 is also communicatively coupled to the processor 40. The printer provides a receipt for each transaction processed by the charity kiosk client 22.

The LED controller 58 may also be communicatively coupled to processor 40. The LED controller 58 is electrically coupled to the LED lights disposed on the charity kiosk client 22. The LED controller 58 is communicatively coupled to the charity kiosk server 24. The charity kiosk server 24 is configured to send an LED instruction to at least one of the charity kiosk clients that activate the LED lights corresponding to the charity kiosk client.

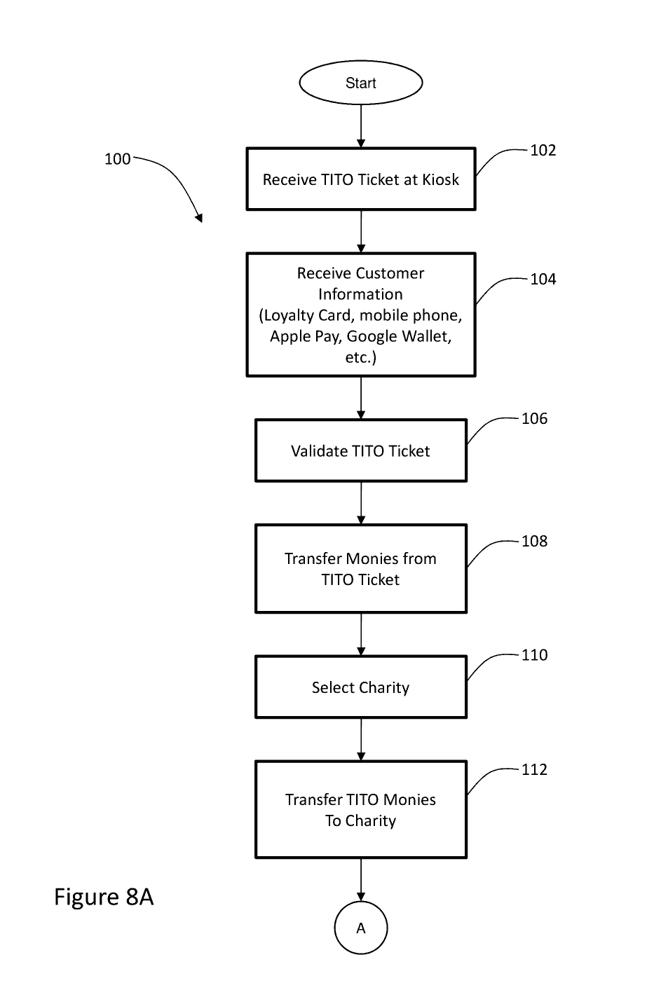

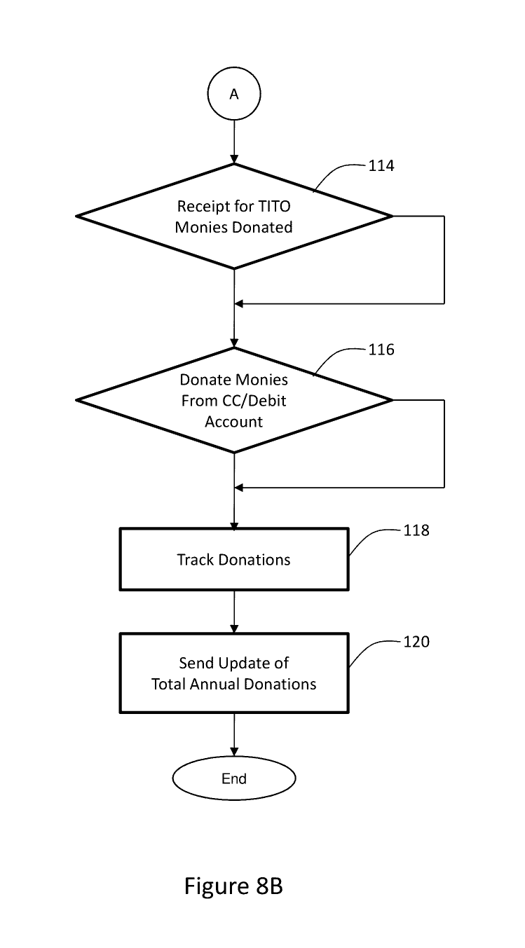

Referring to FIG. 8A there is shown an illustrative flowchart for the user interacting with the charity kiosk client system presented above. The illustrative method is initiated at block 102 wherein the player with a TITO ticket places the TITO ticket into a TITO reader.

At block 104, the charity kiosk client system then proceeds to request specific customer information so that the charity donation may be associated with a particular player. The player information provided at block 104 is used to access the player's charity kiosk account.

The player may input a username and password to access their particular charity donation account. The player may also use their casino property loyalty card, which presently is embodied as a magstripe card. The player may also use their smartphone and a mobile application residing on the smartphone, which operates as an e-wallet, e.g. Apple Pay® or Google Wallet®, to provide specific player information.

In another alternative embodiment, the charity kiosk system includes a downloadable mobile application, which is used to provide the username and password. The smartphone may communicate with the charity kiosk client system using a wireless technology such as NFC, Bluetooth, WiFi or any other such wireless technology.

If the player does not have a charity kiosk account, then the particular player is sent to a user registration page where a user can set up a charity kiosk account. During the charity registration process, the user may then associate their loyalty card, or smartphone with their charity kiosk account.

The method then proceeds to block 106, where the system then proceeds to validate that the TITO ticket has transferable funds. The validation process includes reading the TITO ticket, i.e. voucher. The TITO ticket is printed with the name and the address of the gaming establishment, the stated monetary value of the ticket, date and time, machine number (i.e., asset or location), an 18-digit validation number, and a unique bar code.

At block 108, the method proceeds to transfer the funds associated with the TITO ticket to the charity kiosk system. After the funds are transferred, the TITO ticket is then held in a processed TITO ticket container within the charity kiosk client system.

In the illustrative embodiment presented at block 110, the player selection of the charity occurs after the funds corresponding to the TITO ticket have been transferred to the charity kiosk system.

Alternatively, the player may select the charity during the registration process so that there is little or no need for the charity selection process at block 110. If the player has already selected their charity for donation, then the pre-selected charity is confirmed at block 110.

At block 112, the funds associated with the voucher, e.g. TITO ticket, are transferred from the charity kiosk system to the charity.

The method then proceeds to FIG. 8B where decision diamond 114 determines whether the player wants a receipt. There may be instances where the player would want a receipt and so a receipt is provided. For example, a player may wish to donate to a charity but does not want to register and create a charity kiosk account. Thus, the receipt that is kept by the player may act as a receipt for the donation. In other instances, the player may decide to anonymously contribute to a charity and not want to keep a receipt.

Also, a registered player may elect to not have receipt because the charity kiosk system keeps track of the donations and provides a system and method that logs all the player's donations in a central location.

At decision diamond 116, the player has the option to donate additional funds by accessing their loyalty points or their e-wallet. For example, the player may have the option to convert casino loyalty points to funds, which are donations to the particular charity. Additionally, the player may access their e-wallet and transfer funds from their e-wallet to the particular charity. Thus, the charity kiosk is not limited to simply receiving vouchers, e.g. TITO tickets.

At block 118, the method proceeds to log the transactions by tracking the date, time and location of the transactions. The donations are tracked by the charity kiosk system and are accessible to each particular user by accessing a website or a mobile application.

At block 120, the method sends an update to the particular user monthly or annually. The updates may be sent via email, text or other such communication techniques. The user may use the monthly and annual updates for tax purposes.

Although the systems and methods presented above are directed to registered users, the systems and methods may be adapted to be used for anonymous users that wish to donate voucher proceeds to charities.

It is to be understood that the detailed description of illustrative embodiments are provided for illustrative purposes. Thus, the degree of software modularity for the transactional system and method presented above may evolve to benefit from the improved performance and lower cost of future hardware components that meet the system and method requirements presented. The scope of the claims is not limited to these specific embodiments or examples. Therefore, various process limitations, elements, details, and uses can differ from those just described, or be expanded on or implemented using technologies not yet commercially viable, and yet still be within the inventive concepts of the present disclosure. The scope of the invention is determined by the following claims and their legal equivalents.

What is claimed is:

1. A charity kiosk system that receives a plurality of casino gaming vouchers comprising:
a charity kiosk client that includes,
a voucher scanner configured to read a casino gaming voucher having a monetary value;
an identification module that determines a player identity associated with a particular patron;
a display that presents a plurality of charities;
a charity selection module that receives a charity selection input associated with a selected charity from the plurality of charities;
wherein the charity kiosk client associates the monetary value from the casino gaming voucher with the particular patron and the charity selection input;
a slot accounting system communicatively coupled to the charity kiosk client, wherein the slot accounting system tracks the casino gaming voucher and transfers the monetary value from the casino gaming voucher to the charity kiosk client; and
wherein the charity kiosk client then transfers the received monetary value to the selected charity.

2. The charity kiosk system of claim 1 further comprising a charity kiosk server communicatively coupled to the charity kiosk client, the slot accounting system and a plurality of charity kiosk clients, wherein the charity kiosk server monitors a total monetary value that is donated to each charity by the particular patron.

3. The charity kiosk system of claim 2 wherein the charity kiosk client includes
a plurality of LED lights on the charity kiosk client;
an LED controller electrically coupled to the LED lights, wherein the LED controller is communicatively coupled to the charity kiosk server;
the charity kiosk server configured to send an LED instruction to at least one of the charity kiosk clients that activates the LED lights.

4. The charity kiosk system of claim 2 further comprising,
a banking gateway communicatively coupled to the charity kiosk client;
a banking input module disposed in the charity kiosk client that enables the charity kiosk client to access a player bank account;
wherein funds from the player bank account can be transferred by the charity kiosk client to the selected charity.

5. The charity kiosk system of claim 2 further comprising,
a casino management system communicatively coupled to the charity kiosk client;
a player loyalty input module disposed in the charity kiosk client that enables the charity kiosk client to determine the player identity and a total award points associated with the player identity;
wherein the total award points are converted to a second monetary value by the casino management system so that the second monetary value can be transferred by the charity kiosk client to the selected charity.

6. The charity kiosk system of claim 1 wherein the charity kiosk client further comprises a wireless communication module that enabled the charity kiosk client to be communicatively coupled to a smartphone.

7. The charity kiosk system of claim 6 wherein the player identity associated with the particular patron is stored in the smartphone.
